(19) United States
(12) Patent Application Publication
(10) Pub. No.: US 2011/0277574 A1
(43) Pub. Date: Nov. 17, 2011

(54) CONNECTING APPARATUS OF A VEHICLE SEAT

(75) Inventors: Atsutaka MITSUHASHI, Miyoshi-shi (JP); Takahisa SUZUKI, Hadano-shi (JP)

(73) Assignees: STT INC., Tokyo-to (JP); TOYOTA BOSHOKU KABUSHIKI KAISHA, Aichi-ken (JP)

(21) Appl. No.: 13/108,148

(22) Filed: May 16, 2011

(30) Foreign Application Priority Data
May 17, 2010 (JP) 2010-112871

(51) Int. Cl. F16H 57/10

(52) U.S. Cl. 74/411.5

(57) ABSTRACT

A connecting apparatus of a vehicle seat includes a member with internal teeth; a member with external teeth that is assembled to the member with internal teeth so as to rotate relative to the member with internal teeth while changing a meshing position; a pair of wedge members that are arranged in a gap between the members, and that prevent the members from relative rotation by being urged in a circumferential direction of the connecting members, while sliding against the connecting members, so as to become jammed between the connecting members; and an operating shaft that moves the wedge members in a direction against the urging force, and rotates the gear with external teeth with respect to the gear with internal teeth. A resin composition in which polyethylene has been added to a binder resin is coated onto sliding surfaces of the wedge members.

### INCORPORATION BY REFERENCE

The disclosure of Japanese Patent Application No. 2010-112871 filed on May 17, 2010 including the specification, drawings and abstract is incorporated herein by reference in its entirety.

### BACKGROUND OF THE INVENTION

1. Field of the Invention

The invention relates to connecting apparatus of a vehicle seat. More particularly, the invention relates to a connecting apparatus of a vehicle seat, that connects a first member and a second member that make up a vehicle seat, together in a manner such that the first member and the second member can rotate relative to one another.

2. Description of Related Art

Japanese Patent Application Publication No. 2008-6265 (JP-A-2008-6265) describes a related reclining apparatus (connecting apparatus) of a vehicle seat. This connecting apparatus is configured such that a gear with external teeth and a gear with internal teeth are assembled so as to rotate relative to one another while changing the position in which they mesh together (hereinafter simply referred to as the “meshing position”). A wedge member that stops the rotation by fitting into a gap between the gears in response to spring urging force is provided as means for stopping the relative rotation of the gears. Also, in order to improve the slidability of the wedge member, grease is applied to the member that the wedge member slides against, and the wedge member is coated with a resin composition in which polytetrafluoroethylene (PTFE) particles have been added to a binder resin.

However, with the technology described above, although the PTFE used in the coating material of the wedge member is in itself chemically inactive and nontoxic, it has been noted that it breaks down at or above a certain high temperature and produces a substance that is bad for the environment.

### SUMMARY OF THE INVENTION

The invention thus provides a wedge member that slides well using material that is environmentally friendly.

A first aspect of the invention relates to a connecting apparatus of a vehicle seat, that connects a first member and a second member that form the vehicle seat together such that the first member and the second member rotate relative to one another. This connecting apparatus includes a first connecting member that is fixed to the first member, a second connecting member that is fixed to the second member, a pair of wedge members that are arranged in a gap between the connecting members, a spring member that urges the pair of wedge members, and an operating shaft that operates the wedge members. The first connecting member has a gear with internal teeth. The second connecting member has a gear with external teeth that is assembled so as to rotate relative to the first connecting member while changing a meshing position along an inner peripheral toothed surface of the gear with internal teeth. The wedge members prevent the connecting members from relative rotation by being urged in a circumferential direction of the first and second connecting members, while sliding against the first connecting member and the second connecting member, so as to become jammed between the first and second connecting members. The operating shaft moves the wedge members in a direction against the urging force of the spring, and rotates the gear with external teeth so as to change the meshing position of the gear with the external teeth with respect to the gear with internal teeth. A resin composition in which polyethylene has been added to a binder resin is coated onto sliding surfaces of the wedge members or onto slide receiving surfaces of the connecting members against which the wedge members slide.

According to this example embodiment, coating the sliding surfaces of the wedge members with the resin composition to which polyethylene has been added reduces the sliding resistance of the wedge members and thus improves the slidability of the wedge members. The polyethylene is environmentally friendly and will not produce a substance that is bad for the environment even if subjected to external heat of a high temperature such as welding heat. Also, by being added to the binder resin, the polyethylene is covered with the binder resin. As a result, the polyethylene is provided in a state in which it is strongly bonded to the sliding surfaces of the wedge members, and is not easily affected by the external heat and not easily hardened. Further, the polyethylene powder has a property in which it blends in well with grease, so even if the polyethylene powder separates from the binder resin due to repetitive sliding of the wedge members, it serves to further increase the lubricating ability of the grease by blending in with the grease. In this way, the slidability of the wedge members can be improved using material that is environmentally friendly.

Next, in the first aspect described above, the first member may be fixed to the first connecting member by welding and/or the second member may be fixed to the second connecting member by welding. Also, grease that does not include a solid lubricant may be coated between the sliding surfaces of the wedge members and the slide receiving surfaces of the connecting members against which the wedge members slide.

According to this structure, grease that does not include a solid lubricant, such as polytetrafluoroethylene (PTFE), has, by itself, less lubricating ability than grease that includes a solid lubricant. However, grease that does not include a solid lubricant is less expensive than grease that includes a solid lubricant, and moreover, even if it is subjected to high temperature welding heat, there is no solid lubricant, so a substance that is bad for the environment will not be produced and the grease will not harden. Even if the grease that does not include the solid lubricant is used, the lubricating ability of the grease can be improved by the polyethylene separating from the binder resin as a result of repetitive sliding of the wedge members and blending in with the grease. Therefore, the lubricating ability of the wedge members can be further improved using material that is environmentally friendly.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an exploded perspective view of a reclining apparatus according to one example embodiment of the invention;

FIG. 2 is an overall perspective view of a vehicle seat to which the reclining apparatus has been applied;

FIG. 3 is a front view of the reclining apparatus;

FIG. 4 is a partial sectional view of the internal structure of the reclining apparatus;

FIG. 5 is a partial sectional view showing a state in which an operating member has been rotated clockwise in the drawing and is contacting a wedge member on the left side in the drawing;

FIG. 6 is a partial sectional view showing a state in which the operating member is rotated further and is pushing the wedge member around to the left in the drawing from the state shown in FIG. 5; and

FIG. 7 is a sectional view of a resin composition applied to the sliding surfaces of the wedge members.

### DETAILED DESCRIPTION OF EMBODIMENTS

Hereinafter, example embodiments of the invention will be described with reference to the accompanying drawings.

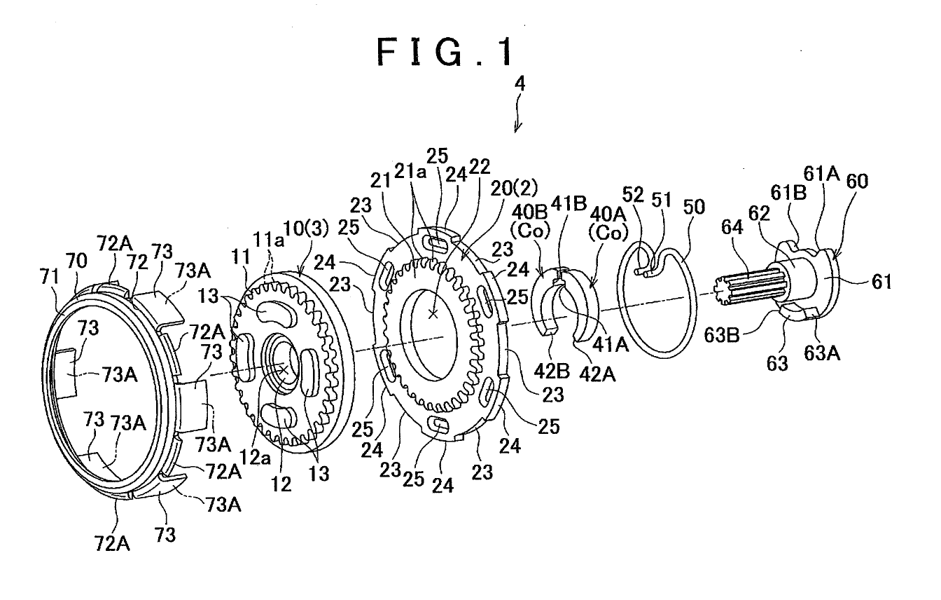

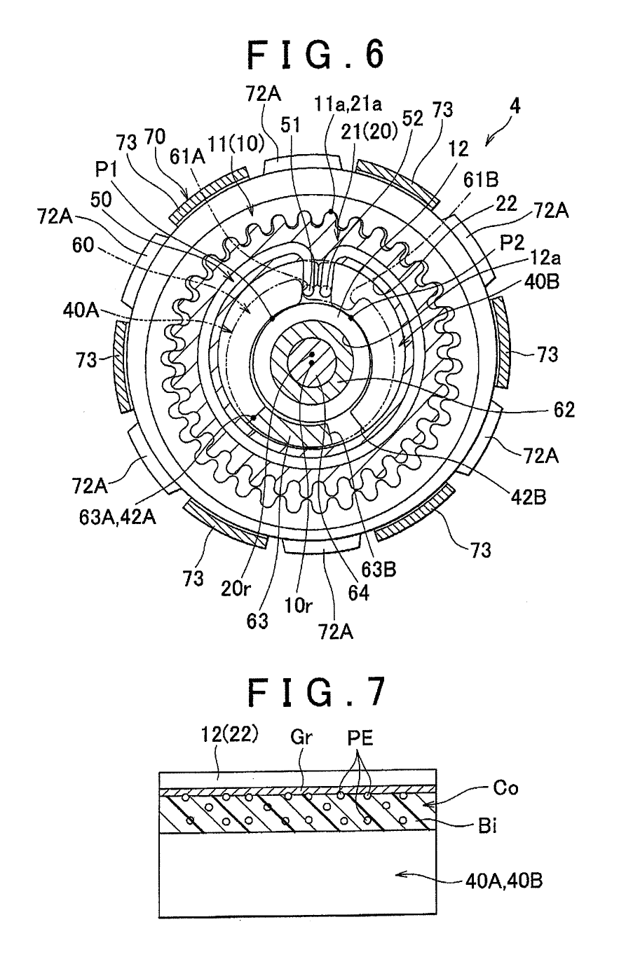

First, the structure of a connecting apparatus of a vehicle seat according to an example embodiment will be described with reference to FIGS. 1 to 7. The connecting apparatus of a vehicle seat according to this example embodiment is provided in a vehicle seat 1 and is structured as reclining apparatuses 4 that connect a seat back 2 to a seat cushion 3 in a manner that enables the back angle to be adjusted. These reclining apparatuses 4 connect lower end portions on the left and right sides of the seat back 2 and to rear end portions on the left and right sides of the seat cushion 3, and tilt (i.e., pivot) the seat back 2 forward or backward with respect to the seat cushion 3 by a coordinated operation of the seat back 2 and the seat cushion 3.

More specifically, the reclining apparatuses 4 are normally prevented from rotating and thus fix the back angle of the seat back 2. The reclining apparatuses 4 change the back angle of the seat back 2 by an operation in which operating shafts 64 that are inserted through the reclining apparatuses 4 are rotated. Here, the operating shafts 64 are connected together by a connecting rod 4r. The operating shafts 64 are rotated as a single unit by the driving of an electric motor, not shown, that is connected to the connecting rod 4r.

The electric motor, not shown, is driven in a forward direction or a reverse direction by the operation of a switch provided on a side portion of the vehicle seat 1, for example, and is switched off by stopping the operation of the switch. Normally, when the operating shafts 64 are not being axially rotatably operated, the reclining apparatuses 4 fix the back angle of the seat back 2. Also, the reclining apparatuses 4 operate to change the back angle of the seat back 2 in response to the operating shafts 64 being axially rotatably operated in unison by the driving of the electric motor.

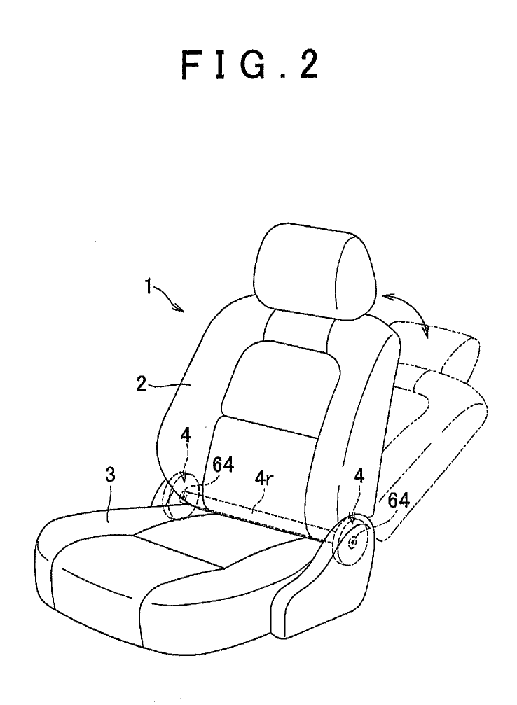

Next, the specific structure of the reclining apparatuses 4 will be described in detail. Here, the reclining apparatuses 4 are both bilaterally symmetrical and have essentially the same structure. Therefore, in the description below, only the structure of the reclining apparatus 4 that is shown on the left side in FIG. 2 will be representatively described.

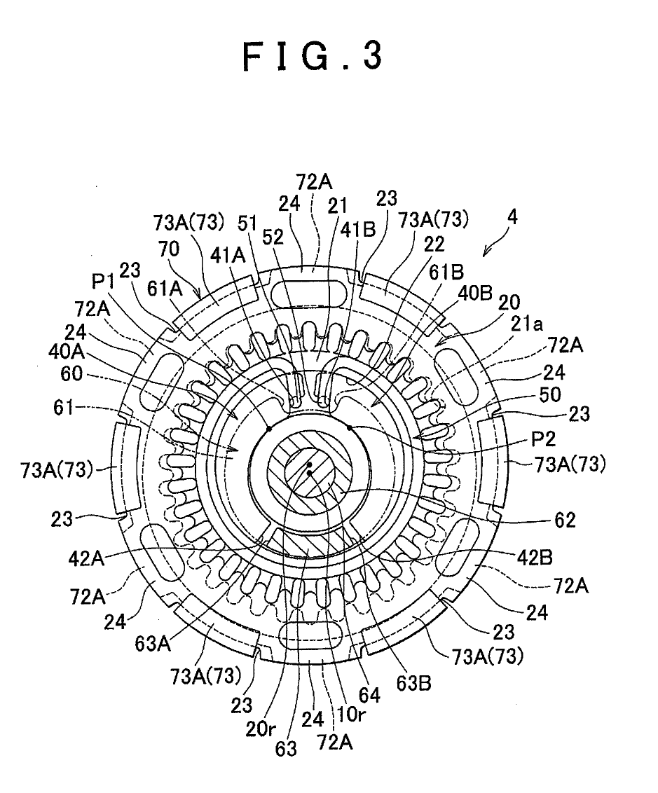

The reclining apparatus 4 is formed by a disc-shaped member with internal teeth 10, a member with external teeth 20, a pair of wedge members 40A and 40B, an open ring-shaped ring spring 50 (that corresponds to the spring of the invention), a disc-shaped operating member 60 integrally provided with the operating shaft 64, and an outer peripheral ring 70 formed in a thin cylindrical shape, all assembled together, as shown in FIG. 1. These members are all assembled together by being set in order in the axial direction (i.e., the direction of the alternate long and short dash line in FIG. 1) in the sequence shown in the drawing (see FIG. 3).

The member with internal teeth 10 is connected and fixed to the seat back 2 (see FIG. 2), and the member with external teeth 20 is connected and fixed to the seat cushion 3 (see FIG. 2). The member with internal teeth 10 and the member with external teeth 20 are assembled so as to be able to rotate relative to one another, as will be described later. Relative rotation between the member with internal teeth 10 and the member with external teeth 20 changes the back angle of the seat back 2 with respect to the seat cushion 3. Here, the seat back 2 serves as the first member of the invention and the seat cushion 3 serves as the second member of the invention.

Next, the specific structure of each of the members described above will be described in detail. First, the structure of the member with internal teeth 10 will be described. As shown in FIG. 1, the member with internal teeth 10 is formed in a disc shape and has a gear with internal teeth 11 that protrudes in a cylindrical shape toward the member with external teeth 20 in the axial direction formed on an outer peripheral edge portion. Internal teeth 11a are formed along the entire circumference on the inner peripheral surface of this gear with internal teeth 11. Also, a cylindrical portion 12 that is concentric with the gear with internal teeth 11 and extends toward the member with external teeth 20 in the axial direction is formed at a center portion of the member with internal teeth 10 (which is also the center portion of the gear with internal teeth 11).

A round circular shaft hole 12a for inserting the operating shaft 64 described above in the axial direction is formed inside the cylindrical portion 12. The gear with internal teeth 11 and the cylindrical portion 12 are each formed by half blanking the member with internal teeth 10 in the direction of plate thickness. The outside face of the member with internal teeth 10 that is on the side opposite the member with external teeth 20 (on the left side in the drawing) is strongly and integrally fixed to the plate surface of a frame, not shown, of the seat back 2 (see FIG. 2) by welding. Consequently, dowels 13 that fit into holes, not shown, formed in the frame of the seat back 2 in order to increase the joint strength with the frame are formed protruding out to the left in the drawing in a plurality of locations (four in this example embodiment) in the circumferential direction.

Next, returning to FIG. 1, the structure of the member with external teeth 20 will be described. The member with external teeth 20 is formed in a disc shape having an outer diameter a size larger than that of the member with internal teeth 10 described above. A gear with external teeth 21 that protrudes out in a cylindrical shape toward the member with internal teeth 10 in the axial direction is formed by half blanking in the direction of plate thickness in the center portion of this member with external teeth 20. External teeth 21a are formed along the entire circumference on the outer periphery of this gear with external teeth 21.

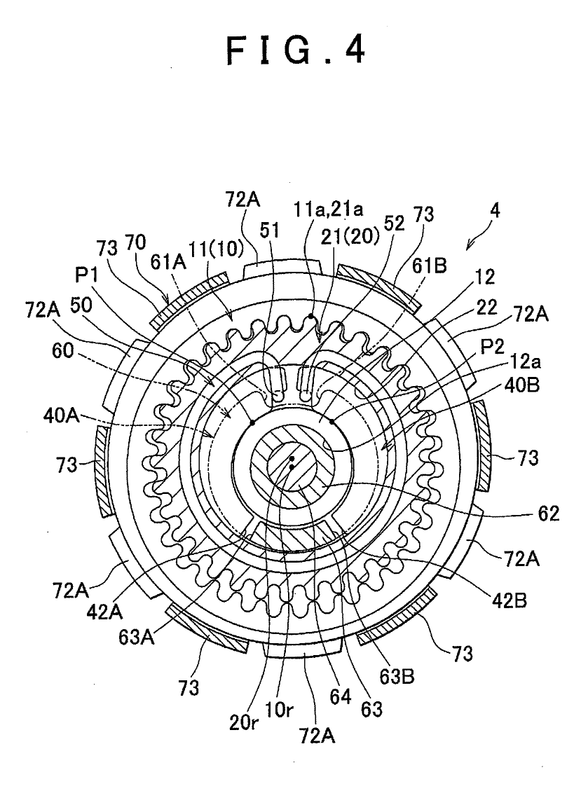

The gear with external teeth 21 described above is formed having a smaller outer diameter than the gear with internal teeth 11 and with fewer teeth than the gear with internal teeth 11. More specifically, the gear with external teeth 21 has 33 external teeth 21a and the gear with internal teeth 11 has 34 internal teeth 11a. Therefore, as shown in FIG. 4, the gear with external teeth 21 is assembled in a state in which it is offset with respect to the gear with internal teeth 11 (i.e., in a state in which the centers 10r and 20r are not aligned), such that the external teeth 21a of the gear with external teeth 21 mesh with the internal teeth 11a of the gear with internal teeth 11, and is thus able to rotate while changing the meshing position along the inner peripheral surface of the gear with internal teeth 11.

The rotational angle of the gear with external teeth 21 with respect to the gear with internal teeth 11 gradually changes due to the difference in the number of teeth between the gears 21 and 11, as the gear with external teeth 21 rotates with respect to the gear with internal teeth 11. Here, returning to FIG. 1, the member with external teeth 20 is formed with concave portions 23 that are recessed in the radial direction and convex portions 24 that bulge out in the radial direction alternately repeating in the circumferential direction. The function of these concave portions 23 and convex portions 24 will be described in detail later.

The outside face of the member with external teeth 20 that is on the side opposite the member with internal teeth 10 (on the right side in the drawing) is strongly and integrally fixed to a plate surface of the frame, not shown, of the seat cushion 3 (see FIG. 2) by welding. Consequently, dowels 25 that fit into holes, not shown, formed in the frame of the seat cushion 3 in order to increase the joint strength with the frame are formed protruding out to the right side in the drawing in a plurality of locations (six locations in this example embodiment) in the circumferential direction, on portions of the outside face of the member with external teeth 20 that are away toward the outside in the radial direction from the gear with external teeth 21.

Accordingly, with this structure, the back angle of the seat back 2 with respect to the seat cushion 3 gradually changes as the gear with external teeth 21 rotates with respect to the gear with internal teeth 11. Incidentally, a large hole 22 that is concentric with the gear with external teeth 21 is formed through the center portion of the member with external teeth 20 (which is also the center portion of the gear with external teeth 21) in the axial direction. When the gear with external teeth 21 is assembled inside the gear with internal teeth 11, the cylindrical portion 12 formed on the member with internal teeth 10 described above is assembled inside this large hole 22, as shown in FIGS. 3 and 4.

More specifically, the gear with external teeth 21 and the gear with internal teeth 11 are assembled with their centers offset from one another, so the positional relationship of the large hole 22 and the cylindrical portion 12 is such that the large hole 22 and the cylindrical portion 12 are not concentric. Instead, their centers 10r and 20r are offset from one another. As a result, an annular gap in which the space changes from wide to narrow in the circumferential direction is formed between the inner peripheral surface of the large hole 22 and the outer peripheral surface of the cylindrical portion 12. In this gap is assembled a pair of wedge portions 40A and 40B that stop relative rotation between the gear with external teeth 21 and the gear with internal teeth 11 and rotate the gear with external teeth 21 to change the meshing position along the inner peripheral surface of the gear with internal teeth 11.

Next, the structure of the wedge members 40A and 40B will be described. The wedge members 40A and 40B are formed in curved shapes that are bilaterally symmetrical to one another, as shown in FIGS. 3 and 4. The inner peripheral surfaces and the outer peripheral surfaces in the radial direction are each gently curved along the gap between the inner peripheral surface of the large hole 22 and the outer peripheral surface of the cylindrical portion 12. That is, the wedge members 40A and 40B have thick portions and thin portions in the radial direction that follow the gap. These wedge members 40A and 40B are set into the gap between the inner peripheral surface of the large hole 22 and the outer peripheral surface of the cylindrical portion 12, thereby filling in part of this gap. Here, the inner peripheral surfaces and the outer peripheral surfaces of the wedge members 40A and 40B correspond to the sliding surfaces of the invention. The inner peripheral surface of the large hole 22 and the outer peripheral surface of the cylindrical portion 12 against which these sliding surfaces slide function as slide receiving surfaces of the invention.

Depressions are formed in a peripheral end portion on the upper side in the drawing where the wedge members 40A and 40B are thick, and these depressions serve as spring hook portions 41A and 41B. One end 51 of a ring spring 50 hooks onto the spring hook portion 41A and the other end 52 of the ring spring 50 hooks onto the spring hook portion 41B. Here, the ring spring 50 applies urging force to the wedge members 40A and 40B in a direction that forces the one end 51 and the other end 52 apart. Accordingly, the urging force of the ring spring 50 constantly pushes the wedge members 40A and 40B in a direction that narrows the gap between the inner peripheral surface of the large hole 22 and the outer peripheral surface of the cylindrical portion 12. In other words, the wedge members 40A and 40B are urged in the circumferential direction of the large hole 22 and/or the cylindrical portion 12, while sliding against the inner peripheral surface of the large hole 22 and the outer peripheral surface of the cylindrical portion 12, so as to become jammed between the inner peripheral surface of the large hole 22 and the outer peripheral surface of the cylindrical portion 12.

In this state, the inner peripheral surfaces of the wedge members 40A and 40B contact the outer peripheral surface of the cylindrical portion 12 at two points P1 and P2 on the left and right of a circumferential region on the upper side in the drawing. Because the urging force of the ring spring 50 pushes the wedge members 40A and 40B in the direction that narrows the gap between the inner peripheral surface of the large hole 22 and the outer peripheral surface of the cylindrical portion 12, the wedge members 40A and 40B press the inner peripheral surface of the large hole 22 upward in the drawing with respect to the outer peripheral surface of the cylindrical portion 12, and thus press the gear with external teeth 21 in the radial direction against the inner peripheral surface of the gear with internal teeth 11.

As a result, backlash in the gears 11 and 21 is eliminated, so rotation is prevented (see FIG. 4). The state in which the rotation of the gears 11 and 21 is prevented by the wedge members 40A and 40B being pushed in the direction that narrows the gap is released by an operating portion 63 of the operating member 60, that is provided between lower tip end portions that form the tips of the wedge members 40A and 40B, being axially rotated in one direction or the other.

Next, the structure of the operating member 60 will be described. The operating member 60 has a disc-shaped retainer plate 61, a cylindrical portion 62 formed protruding out in the axial direction at the center portion of this retainer plate 61, an operating portion 63 formed protruding out from the retainer plate 61 in an arc-shape on the same side in the axial direction as the cylindrical portion 62, and an operating shaft 64 that is fit into the center portion of the cylindrical portion 62 in the axial direction and coupled to the cylindrical portion 62.

The operating member 60 described above is assembled with the cylindrical portion 62 set inserted into the cylindrical portion 12 of the member with internal teeth 10 such that the cylindrical portion 62 is axially rotatably supported by the cylindrical portion 12 of the member with internal teeth 10, as shown in FIGS. 3 and 4. With this assembly, the operating member 60 is assembled such that the disc-shaped retainer plate 61 covers the wedge members 40A and 40B that are assembled between the inner peripheral surface of the large hole 22 and the outer peripheral surface of the cylindrical portion 12; and guides the wedge members 40A and 40B so that they do not fall out.

Incidentally, in FIGS. 3 to 6, the retainer plate 61 is shown by a virtual line in order to more easily show the assembled state of the wedge members 40A and 40B. The operating member 60 described above is assembled with the operating portion 63 fit into the space between the lower tip end portions that form the tips of the wedge members 40A and 40B. Therefore, when the operating shaft 64 that is integrally assembled to the operating member 60 is axially rotatably operated to one side or the other, the operating member 60 pushes on the lower end surface (i.e., a pushed surface 42A (42B)) of the wedge member 40A (40B) on one side or the other with an end surface (i.e., a pushing surface 63A (63B)) of the operating portion 63 according to the direction in which the operating shaft 64 is rotatably operated.

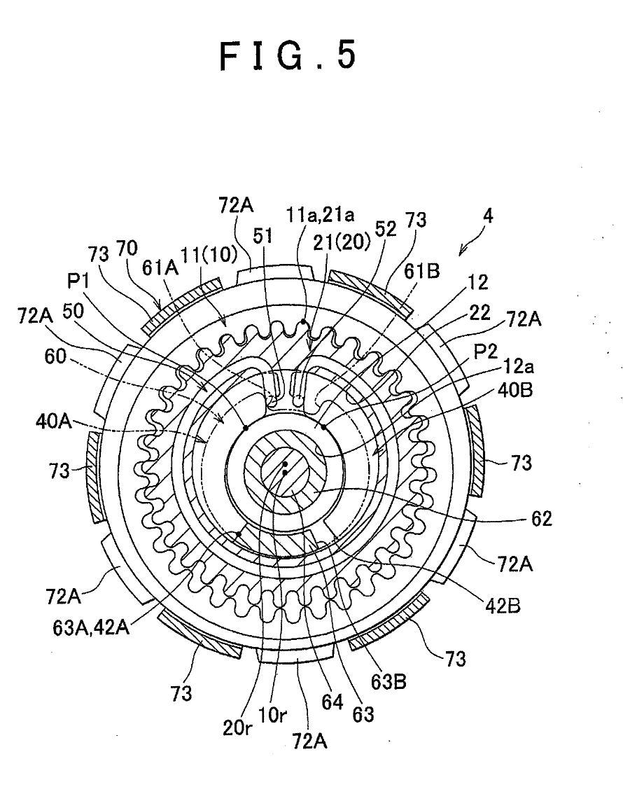

More specifically, as shown in FIG. 5, when the operating member 60 is rotatably operated in the clockwise direction in the drawing by the operating shaft 64, for example, the end surface (i.e., the pushing surface) on the left side in the drawing of the operating portion abuts against the pushed surface of the wedge member 40A on the left side in the drawing, thereby pushing the wedge member 40A around in the rotational direction. As a result, that wedge member 40A is pushed out of the narrow gap, between the inner peripheral surface of the large hole 22 and the outer peripheral surface of the cylindrical portion 12, such that the gap is no longer taken up by the wedge members 40A and 40B.

At this time, the operating member 60 pushes the wedge member 40A clockwise in the drawing, while releasing the urging force of the ring spring 50 applied to the wedge member 40A on the left in the drawing by pushing the one end 51 of the ring spring 50 that is hooked onto the wedge member 40A on the left in the drawing in the same direction using one of two spring pushing portions 61A and 61B (i.e., the spring pushing portion 61A on the left in the drawing) formed on the outer peripheral portion of the retainer plate 61, as the operating member 60 rotates. As a result, the operating member 60 is able to directly push the ring spring in the direction opposite the direction in which the urging force of the ring spring 50 acts, so the wedge member 40A is able to be smoothly pushed.

Further, when the wedge member 40A is pushed around clockwise in the drawing as described above by the operating member 60, the upper tip end portion of the wedge member 40A that has been rotated abuts against the upper end portion of the wedge member 40B on the right side. As a result, the wedge member 40B is pushed along so that it rotates around in the same direction. This rotation of the wedge members 40A and 40B causes the direction in which the wedge members 40A and 40B push to gradually change from a direction in which they push on the inner peripheral surface of the large hole 22 of the member with external teeth 20 (i.e., in the radial direction) to the circumferential direction. As a result, the meshing position where the gear with external teeth 21 meshes with the gear with internal teeth 11 changes in the counterclockwise direction in the drawing along the inner peripheral surface of the gear with internal teeth 11. That is, the gear with external teeth 21 rotationally moves in the counterclockwise direction.

When relative rotation of the two gears 21 and 11 comes to be in a state in which a rotational operation of the operating member 60 is prevented and the wedge members 40A and 40B are once again pushed into the narrowing gap between the inner peripheral surface of the large hole 22 and the outer peripheral surface of the cylindrical portion 12 by the urging force of the ring spring 50, relative rotation of the two gears 21 and 11 returns to the state in which rotation is prevented, i.e., returns to the same state as that described above (see FIG. 4). Incidentally, when the operating member 60 is rotatably operated counterclockwise which is reverse from the rotational direction described above, the wedge members 40A and 40B move in the opposite direction from that described above.

Next, returning to FIG. 1, the structure of the outer peripheral ring 70 will be described. The outer peripheral ring 70 is formed of a thin steel plate that has been stamped out in a ring shape. Moreover, the inner peripheral portion and the outer peripheral portion are formed as a ring-shaped first seating surface portion 71 and ring-shaped second seating surface portion 72, respectively; that face in the axial direction in a stepped manner, by half blanking the ring portion of the hollow circular disc in the direction of thickness (i.e., the axial direction). Furthermore, a plurality of fin pieces 73 extend out in the axial direction from the outer peripheral portion side of the second seating surface portion 72.

More specifically, an abutting portion 72A that extends a surface toward the outside in the radial direction flush with the second seating surface portion 72, and the fin pieces 73 described above, are formed repeating alternately in the circumferential direction on the outer peripheral portion of the second seating surface portion 72. The member with internal teeth 10 and member with external teeth 20 are assembled inside the cylindrical portion of the outer peripheral ring 70 structured as described above, so the first seating surface portion 71 abuts against the outside face of the gear with internal teeth 11 in the axial direction, and the second seating surface portion 72 abuts against the inside face of the member with external teeth 20 in the axial direction.

More specifically, the second seating surface portion 72 is in a state in which abutting portions 72A that are formed on the outer peripheral portion of the second seating surface portion 72 and that abut with the inside face of the member with external teeth 20 are made to abut in the axial direction with the convex portions 24 that are formed on the outer peripheral portion of the member with external teeth 20. As a result, the member with external teeth 20 is abutted over a wide surface with the second seating surface portion 72. Also, by having the member with external teeth 20 assembled in the cylinder of the outer peripheral ring 70, the fin pieces 73 that are formed on the outer peripheral ring 70 fit, in the axial direction, in the concave portions 23 that are formed on the outer peripheral portion of the member with external teeth 20.

Then, protruding parts (i.e., crimping portions 73A) at the tips of the fin pieces 73 that are fit into the concave portions 23 and protrude out in the axial direction are crimped in the axial direction by being folded to the inside in the radial direction so as to sandwich the member with external teeth 20 with the second seating surface portion 72. As a result; the outer peripheral ring 70 becomes integrally assembled with the member with external teeth 20. Thus, the outer peripheral ring 70 sandwiches the member with external teeth 20 and the member with internal teeth 10 in the axial direction, while keeping the gear with external teeth 21 and the gear with internal teeth 11 able to rotate relative to each other.

Incidentally, a resin composition Co is coated on the inner peripheral surface and the outer peripheral surface, i.e., the sliding surfaces, of the wedge members 40A and 40B in order to reduce frictional resistance during sliding. Moreover, grease Gr that does not include a solid lubricant is coated on the inner peripheral surface of the large hole 22 of the member with external teeth 20 and the outer peripheral surface of the cylindrical portion 12 of the member with internal teeth 10, against which the wedge members 40A and 40B slide.

More specifically, this resin composition Co is a composition in which polyethylene powder PE has been added to a binder resin Bi. A film is formed on the sliding surfaces of the metal wedge members 40A and 40B and is strongly bonded to the sliding surfaces, by coating the sliding surfaces of the wedge members 40A and 40B with the resin composition Co according to an immersion or spraying method and then heat curing it for 30 minutes at 200° C. Epoxy resin to which xylene that serves as a curing agent has been added may be used as the binder resin Bi. Alternatively, polyamide resin, a polyimide resin, an epoxy resin, a phenol resin, or a silicone resin or the like may be used as the binder resin.

The binder resin Bi inhibits thermal degradation by covering and protecting the polyethylene powder PE, strongly adheres to the wedge members 40A and 40B that are the foundation, and binds the polyethylene powder PE. The polyethylene powder PE may be a powder for molding or a so-called fine powder for a solid lubricant. The polyethylene powder PE is environmentally friendly and will not produce a substance that is bad for the environment, even if it reaches a high temperature when externally exposed to high temperature welding heat produced when the member with external teeth 20 and the member with internal teeth 10 are welded to the frame of the seat cushion 3 and the seat back 2; respectively. By being added to the binder resin Bi, this polyethylene powder PE is covered with the binder resin Bi. As a result, the polyethylene powder PE is provided in a state in which it is strongly bonded to the sliding surfaces of the wedge members 40A and 40B, and is not easily affected by external heat and not easily hardened.

The grease Gr is grease that does not include a solid lubricant for improving the lubricating ability, such as polytetrafluoroethylene (PTFE) particles. Therefore, even if externally exposed to the high temperature welding heat, a substance that is bad for the environment will not be produced because there is no solid lubricant, and the lubricating ability will not deteriorate due to hardening. Also, the polyethylene powder PE has a property that blends in well with grease Gr, so even if the polyethylene powder PE separates from the binder resin Bi due to repetitive sliding of the wedge members 40A and 40B, it serves to further increase the lubricating ability of the grease Gr, as if to blend in with grease and function as a solid lubricant.

Therefore, although the grease Gr itself has less lubricating ability than grease that includes a solid lubricant does, the grease Gr is also less expensive than grease that includes a solid lubricant, and, by blending in the polyethylene powder PE that separates from the binder Bi from repetitive sliding of the wedge members 40A and 40B as described above, the polyethylene powder PE functions as a solid lubricant, which improves the lubricating ability. In this way, the slidability of the wedge members 40A and 40B can be improved using material that is environmentally friendly.

Heretofore, one example of the invention has been described. However, the invention may also be carried out in various other modes. For example, in the example embodiment described above, the reclining apparatus 4 that connects the seat back 2 to the seat cushion 3 in a manner such that the back angle can be adjusted is given as an example of the connecting apparatus of a vehicle seat. However, the connecting apparatus of a vehicle seat may also be applied to various uses for connecting two members that form a vehicle seat in a state in which the two members are able to rotate relative to each other. More specifically, the invention may be applied to an apparatus that rotatably connects an ottoman to a front portion of the seat cushion 3, for example.

Also, in the example embodiment described above, the resin composition Co is coated on the sliding surfaces of the wedge members 40A and 40B in order to improve the slidability of the wedge members 40A and 40B. However, the resin composition Co may also be coated on the inner peripheral surface of the large hole 22 of the member with external teeth 20 and the outer peripheral surface of the cylindrical portion 12 of the member with internal teeth 10, that form the slide receiving surfaces against which the wedge members 40A and 40B slide.

What is claimed is:

1. A connecting apparatus of a vehicle seat, that connects a first member and a second member that form the vehicle seat together such that the first member and the second member rotate relative to one another, comprising:
a first connecting member that is fixed to the first member and has a gear with internal teeth;
a second connecting member that is fixed to the second member and has a gear with external teeth that is assembled so as to rotate relative to the first connecting member while changing a meshing position along an inner peripheral toothed surface of the gear with internal teeth;
a pair of wedge members that are arranged in a gap between the first and second connecting members, and that prevent the first and second connecting members from relative rotation by being urged in a circumferential direction of the first and second connecting members, while sliding against the first connecting member and the second connecting member, so as to become jammed between the first and second connecting members;
a spring member that urges the pair of wedge members in the circumferential direction; and
an operating shaft that moves the wedge members in a direction against the urging force of the spring member, and rotates the gear with external teeth so as to change the meshing position of the gear with the external teeth with respect to the gear with internal teeth,
wherein a resin composition in which polyethylene has been added to a binder resin is coated onto sliding surfaces of the wedge members or onto slide receiving surfaces of the first and second connecting members against which the wedge members slide.

2. The connecting apparatus of a vehicle seat according to claim 1, wherein the first member is fixed to the first connecting member by welding and/or the second member is fixed to the second connecting member by welding; and grease that does not include a solid lubricant is coated between the sliding surfaces of the wedge members and the slide receiving surfaces of the connecting members against which the wedge members slide.

3. The connecting apparatus of a vehicle seat according to claim 1, wherein a cylindrical portion that extends toward the second connecting member is provided at a center portion of the first connecting member; a hole that is larger than the cylindrical portion is provided in a center portion of the second connecting member; and the wedge members are arranged in a gap between an outer peripheral portion of the cylindrical portion and an inner peripheral surface of the hole.

4. The connecting apparatus of a vehicle seat according to claim 3, wherein each of the wedge members is curved along the inner peripheral surface of the hole, and a thickness of the wedge members in a radial direction of a radius of curvature gradually changes.
